(19) United States
(12) Patent Application Publication
(10) Pub. No.: US 2019/0187820 A1
(43) Pub. Date: Jun. 20, 2019

(54) ELECTRONIC DEVICE INCLUDING STYLUS AND METHOD OF OPERATING THE SAME

(71) Applicant: Samsung Display Co., Ltd., Yongin-si (KR)

(72) Inventor: Byung Hyun KIM, Yongin-si (KR)

(21) Appl. No.: 16/121,647

(22) Filed: Sep. 5, 2018

(30) Foreign Application Priority Data
Dec. 19, 2017 (KR) 10-2017-0175215

(51) Int. Cl. G06F 3/0354; G06F 3/041; G06F 3/0481

(52) U.S. Cl. CPC G06F 3/03545; G06F 3/0481; G06F 3/03547; G06F 3/0412

(57) ABSTRACT

An electronic device includes a input member including a first input unit and a second input unit spaced apart from each other; an input sensing unit to sense a position of the first input unit and a position of the second input unit; and a processor to generate correction coordinate information based on the position of the first input unit and the position of the second input unit.

### CROSS-REFERENCE TO RELATED APPLICATION

This application claims priority from and the benefit of Korean Patent Application No. 10-2017-0175215, filed on Dec. 19, 2017, which is hereby incorporated by reference for all purposes as if fully set forth herein.

### BACKGROUND

### Field

Exemplary implementations of the invention relate generally to display device with input sensing unit, and, more specifically, to an electronic device including a stylus and a method of operating the same to correct for errors.

### Discussion of the Background

Electronic devices having the function of indicating position by touching a touch panel mounted thereon are widely used. In particular, touch sensors are widely used due to the spread of mobile electronic devices such as a smart phone or a tablet computer.

Recently, there is an increasing demand for the technique of recognizing a touch on a touch panel by using tools other than a finger, such as a stylus pen.

The stylus pen can be embodied in various ways. For example with Electro Magnetic Resonance (EMR) technology available from companies such as Wacom, the stylus pen may sense the input using resonance with an EMR sensor pad.

The above information disclosed in this Background section is only for understanding of the background of the inventive concepts, and, therefore, it may contain information that does not constitute prior art.

### SUMMARY

Applicant realized that input errors are introduced when using a pointing device to indicate position on a touch panel due to the combined thickness of the components such as the display device, touch panel and protective window.

Electronic devices and methods of operating the electronic devices constructed according to the principles and exemplary implementations of the invention are capable of improving the accuracy of pointer position.

Additional features of the inventive concepts will be set forth in the description which follows, and in part will be apparent from the description, or may be learned by practice of the inventive concepts.

According to one aspect of the invention, an electronic device includes an input member including a first input unit and a second input unit spaced apart from each other; an input sensing unit configured to sense a position of the first input unit and a position of the second input unit; and a processor configured to generate correction coordinate information based on the position of the first input unit and the position of the second input unit.

The electronic device may further include a display unit configured to display a pointer image corresponding to the correction coordinate information; and a window unit disposed on the display unit.

The correction coordinate information may correspond to an intersection point between an extension line of the input member and the display unit.

The first input unit and the second input unit may be arranged along the extension line of the input member.

The input sensing unit may be configured to generate first coordinate information and second coordinate information indicating planar coordinates of a first input point and a second input point of the first input unit and the second input unit, respectively.

The processor may configured to obtain a first length indicating a first distance between the first input point and the second input point and obtain a second length indicating a second distance from an upper surface of the display unit to an upper surface of the window unit.

The first length and the second length may be predetermined values and be stored in a memory.

The processor may be configured to calculate a third length indicating a third distance between a point corresponding to the first coordinate information and a point corresponding to the second coordinate information.

When the input member is in a contact state, the host device may be configured to is calculate a correction distance using equation 1, [Equation 1] x=(L2*L3)/((L1̂2−L3̂3)̂(½)), wherein x is the correction distance, L1 is the first length, L2 is the second length and L3 is the third length.

The processor may be configured to generate the correction coordinate information corresponding to a point spaced by the correction distance from a point corresponding to the first coordinate information, in a direction from the second coordinate information to the first coordinate information.

The input sensing unit may be configured to generate first height information and second height information indicating a distance of the first input point from the window unit and a distance of the second input point from the window unit, respectively.

When the input member is in a release state, the host device may be configured to obtain a fourth length based on the first height information.

The processor may be configured to calculate the correction distance using Equation 2, [Equation 2] x=((L2+L4)*L3)/((L1̂2−L3̂3)̂(½)), wherein x is the correction distance, L1 is the first length, L2 is the second length, L3 is the third length and L4 is the fourth length.

When the input member is in a release state, the host device may be configured to obtain a fourth length, and the fourth length is a predetermined value and is stored in a memory.

The input member may include a stylus, and the first input unit may be formed as a pen tip of the stylus.

According to another aspect of the invention, a method of operating an electronic device having an input member with a first input unit and a second input unit spaced apart from each other, an input sensing unit, a host device to generate correction coordinate information, a display unit to display an image, and a window unit disposed on the display unit, the method includes the steps of: generating first coordinate information and second coordinate information representative of planar coordinates of a first input point and a second input point of the first input unit and the second input unit, respectively; obtaining a first length indicating a distance between the first input point and the second input point; obtaining a second length indicating a distance from an upper surface of the display unit to an upper surface of the window unit; calculating a third length indicating a distance between a point corresponding to the first coordinate information and a point corresponding to the second coordinate information; determining a state of the input member; calculating a correction distance, when the input member is in a first state; and generating the correction coordinate information based on the first coordinate information, the second coordinate information, and the correction distance.

The first state is a contact state and the step of calculating of the correction distance may include calculating the correction distance using equation 1, [Equation 1] x=(L2*L3)/((L1̂2−L3̂3)̂(½)), wherein x is the correction distance, L1 is the first length, L2 is the second length and L3 is the third length.

The first state is a release state and the method of operating an electronic device may further include obtaining a fourth length indicating a distance of the first input point the window unit.

The calculating of the correction distance may include the step of calculating the correction distance using equation 2, [Equation 2] x=((L2+L4)*L3)/((L1̂2−L3̂3)̂(½)), wherein x is the correction distance, L1 is the first length, L2 is the second length, L3 is the third length and L4 is the fourth length.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a perspective view of an exemplary embodiment of an electronic device constructed according to the principles of the invention.

FIG. 2 is a cross-sectional view of the electronic device shown in FIG. 1.

FIG. 3 is a schematic, perspective diagram illustrating an exemplary embodiment of a stylus constructed according to the principles of the invention.

FIG. 4 is a schematic, cross sectional view of the stylus of FIG. 3 in a state contacting the window unit of a display device according to an exemplary embodiment.

FIG. 5 is a schematic, cross sectional view of the stylus of FIG. 3 in a release (no-contact) state according to an exemplary embodiment.

FIG. 6 is a schematic block diagram illustrating components of an electronic device constructed according to the principles of the invention.

FIG. 7 is a flowchart for a exemplary method of operating an electronic device according to the principles of the invention.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

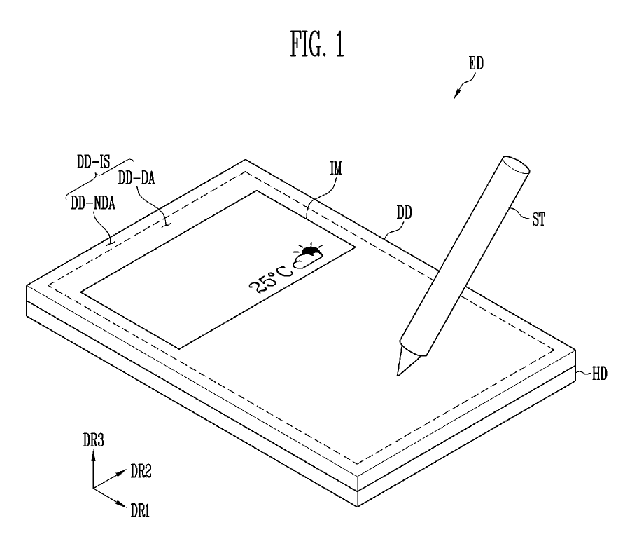

FIG. 1 is a perspective view of an exemplary embodiment of an electronic device constructed according to the principles of the invention.

Referring to FIG. 1, an electronic device ED may include a display device DD, a input member such as a stylus ST, and a host device HD.

The display device DD may include a display surface DD-IS.

The display surface DD-IS may be located on a front surface of the display device DD. The display device DD may display an image IM through the display surface DD-IS. The display surface DD-IS may be substantially parallel to the plane defined by a first direction DR1 and a second direction DR2. The normal direction, that is, a thickness direction along the display surface DD-IS of the display device DD may be indicated by a third direction DR3.

A front surface (or the upper surface) and a back surface (or lower surface) of each of the members or units described below are delineated in the third direction DR3. However, the first, second, and third directions DR1, DR2 and DR3 shown in this embodiment are merely examples. Since the first, second, and third directions DR1, DR2 and DR3 are relative concepts, they may be converted to other directions. Hereinafter, the first, second, and third directions are indicated by the first to third directions DR1, DR2, DR3, respectively, and the same reference numerals are used.

In an exemplary embodiment, the display surface DD-IS of the display device DD may be illustrated as a planar display surface, but the inventive concepts are not limited thereto. The display surface DD-IS of the display device DD may include a curved display surface or a stereoscopic display surface.

The stereoscopic display surface DD-IS may include a plurality of display areas indicating different directions, and may include, for example, a polygonal columnar display surface.

The display device DD according to some exemplary embodiments may be a rigid display device. However, the inventive concepts are not limited thereto, and the display device DD according to the may be a flexible display device.

The display device DD is exemplarily shown in the illustrated embodiment is applied to a mobile phone terminal. Electronic modules, a camera module, a power module, and the like mounted on a main board may be arranged in a bracket/case together with the display device DD to constitute a mobile phone terminal. The display device DD according to the exemplary embodiment also may be applied to other kinds of displays, including a large electronic device such as a television, a monitor, etc., and a small-sized electronic device such as a tablet, a car navigation device, a game device, a smart watch, etc.

As shown in FIG. 1, the display surface DD-IS may include a display area DD-DA where the image IM is displayed and a non-display area DD-NDA adjacent to the display area DD-DA. The non-display area DD-NDA is an area where no image is displayed. FIG. 1 shows temperature and weather images as an example of the image IM.

As shown in FIG. 1, the display area DD-DA may have a rectangular shape. The non-display area DD-NDA may surround the display area DD-DA. However, the inventive concepts are not limited to this, and the shape of the display area DD-DA and the shape of the non-display area DD-NDA may be relatively designed.

The stylus ST may be a device capable of performing various inputs to the display device DD as directed by a user's hand.

In FIG. 1, the stylus ST is shown as a pen-shaped instrument, but the inventive concepts are not limited thereto. According to the particular embodiment, the stylus ST may be designed in various shapes.

The host device HD may control the overall operation of the electronic device ED. That is, the host device HD may control the overall operation of the display device DD and the stylus ST. For example, the host device HD may correct the position indicated by the stylus ST, that is, the position of the pointer.

In FIG. 1, the host device HD is shown as being located on the opposite side of the display surface DD-IS of the display device DD, but the inventive concepts are not limited thereto. Accordingly, the host device HD and the display device DD may be integrated.

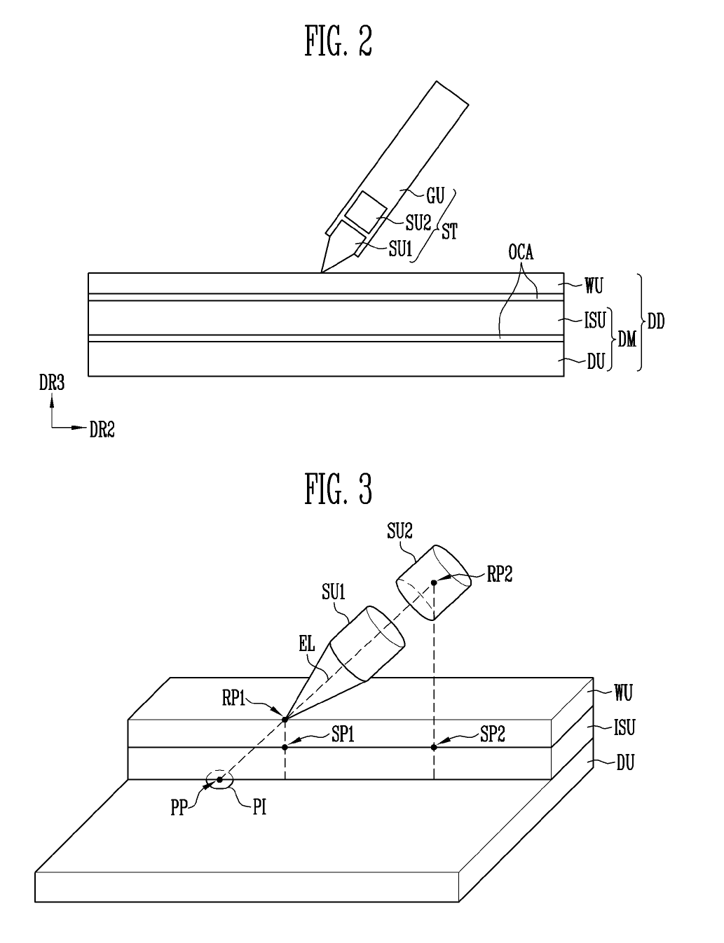

FIG. 2 is a cross-sectional view of the electronic device shown in FIG. 1.

For convenience of illustration, the host device HD shown in FIG. 1 is omitted from FIG. 2.

FIG. 2 shows a cross section defined by the second direction DR2 and the third direction DR3. In FIG. 2, the electronic device is simplified to illustrate the stacking relationship of the functional panels and/or functional units constituting the display device DD.

The display device DD according to the illustrated embodiment may include a display unit DU, an input sensing unit ISU, and a window unit WU.

At least some of the display unit, the input sensing unit, the reflection preventing unit, and the window unit may be formed by a continuous process, or at least some of the units may be coupled to each other through an adhesive member. In FIG. 2, an optical clear adhesive member OCA is illustrated by way of example as an adhesive member. The adhesive member described below may include a conventional adhesive or a pressure-sensitive adhesive. According to some embodiments, the window unit may be replaced with another component or omitted.

Unlike the embodiment shown in FIG. 2, the input sensing unit ISU and the window unit WU may be formed as different components through a continuous process. As shown in FIG. 2, the input sensing unit ISU and the window unit WU may be coupled with other components via an adhesive member.

The input sensing unit and the window unit may be referred to as an input sensing panel and a window panel, or an input sensing layer and a window layer, depending on the presence or absence of a base layer.

More specifically, the “panel” includes a base layer providing a base surface, such as a synthetic resin film, a composite film, a glass substrate, and the like. However, the base layer may be omitted from the “layer”. In other words, the units represented by the “layer” may be disposed on the base surface provided by another unit.

In this specification, use of the phrase “the configuration B is directly disposed on the configuration A” means that no separate adhesive layer/adhesion member is disposed between the configuration A and the configuration B. The configuration B may be formed through a continuous process on the base surface provided by the A configuration A after the A configuration is formed.

As shown in FIG. 2, the display device DD may include the display unit DU, the input sensing unit ISU, and the window unit WU.

The display unit DU may generate an image. For example, the display unit DU may be a display panel capable of displaying an image.

The optical clear adhesive member OCA may be disposed between the display unit DU and the input sensing unit ISU.

The display unit DU and the input sensing unit ISU may be defined as a display module DM.

The optical clear adhesive member OCA may be disposed between the display module DM and the window unit WU.

The display unit DU according to an exemplary embodiment may be a light emitting display panel and is not particularly limited. For example, the display unit DU may be an organic light emitting display panel or a quantum dot light emitting display panel. A light emitting layer of the organic light emitting display panel may include an organic light emitting material. The light emitting layer of the quantum dot light emitting display panel may include quantum dots, quantum rods, and the like. Hereinafter, the display unit DU is described for convenience as an organic light emitting display panel.

The input sensing unit ISU may obtain coordinate information or pressure information of an external input (e.g., a touch event) by a stylus as in known in the art.

The display module DM according to an exemplary embodiment may further include a protection member disposed on a lower surface of the display unit DU.

The protective member and the display unit DU may be coupled through the adhesive member.

The window unit WU according to an exemplary embodiment may include a base film and a light shielding pattern.

The base film may include a glass substrate and/or a synthetic resin film or the like. The base film is not limited to a single layer. The base film may comprise two or more films bonded with an adhesive member.

The light shielding pattern may be partially overlapped with the base film. The light shielding pattern may be disposed on the back surface of the base film to define a bezel area of the display device DD, that is, a non-display area DD-NDA (see FIG. 1). The light shielding pattern may be formed as a colored organic film, for example, by a coating method.

The window unit WU may further include a functional coating layer disposed on the front surface of the base film. The functional coating layer may include an anti-fingerprint layer, an anti-reflection layer, and a hard coat layer.

Referring to FIGS. 1 and 2, the input sensing unit ISU may be entirely overlapped with the display area DD-DA. However, the inventive concepts are not limited thereto. According to the particular embodiment, the input sensing unit ISU may overlap only a part of the display area DD-DA, or may overlap only the non-display area DD-NDA.

The input sensing unit ISU may be a touch sensing panel for sensing a user's touch, or a fingerprint sensing panel for sensing fingerprint information of a user's finger.

The input sensing unit ISU may be a sensing panel that senses a signal transmitted from the stylus ST or senses a touch with the stylus ST.

The stylus ST may include a first input unit SU1, a second input unit SU2, and a grip unit GU. As discussed herein, the input units SU1 and SU2 may take any form known in the art capable of producing a signal that can be sensed by the input sensing unit ISU, such as pressure, electrostatic capacity and/or an electromagnetic signal, e.g., as generated by an induction coil.

The first input unit SU1 may be formed as a pen-tip of the stylus ST. However, the inventive concepts are not limited thereto, and according to the particular embodiment, the first input unit SU1 may be designed in various shapes.

The second input unit SU2 may be spaced apart from the first input unit SU1. For example, the second input unit SU2 may be spaced apart from the first input unit SU1 along the direction in which the grip unit GU extends.

The grip unit GU may surround the first input unit SU1 and the second input unit SU2. For example, the user may grasp the grip unit GU with the user's hand.

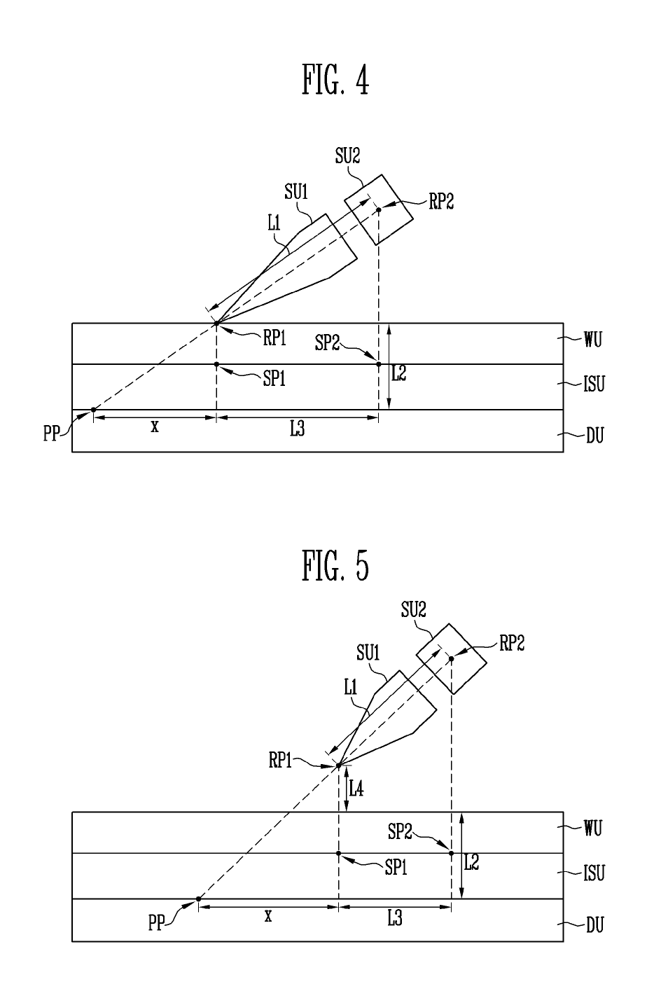

According to an embodiment, the first input unit SU1 and the second input unit SU2 may be arranged along an extension line EL (see FIG. 3) of the stylus ST.

The input sensing unit ISU may sense the position of the first input unit SU1 and the position of the second input unit SU2. The details thereof are described in reference to FIG. 3.

FIG. 3 is a schematic, perspective diagram illustrating an exemplary embodiment of a stylus constructed according to the principles of the invention.

For convenience of illustration, the host device HD shown in FIG. 1, and the optical clear adhesive member OCA and the grip unit GU of the stylus ST shown in FIG. 2, are not shown in FIG. 3.

Further, only a portion of the window unit WU and the input sensing unit ISU shown in FIG. 2 is shown in FIG. 3.

Referring to FIG. 3, the host device HD may correct the position indicated by the stylus ST, that is, the position of the pointer. For example, the host device HD may generate correction coordinate information PP based on the position of the first input unit SU1 and the position of the second input unit SU2. The correction coordinate information PP may indicate the corrected position of the pointer. According to an embodiment, the correction coordinate information PP may correspond to the intersection point PI between the extension line EL of the stylus ST and the display unit DU.

For example, the position of the first input unit SU1 may be defined as a first input point RP1, and the position of the second input unit SU2 may be defined as a second input point RP2.

As shown in FIG. 3, the first input point RP1 may be located at the vertex of the first input unit SU1 shaped as a pen tip and the second input point RP2 may be located at the center of the second input unit SU2. However, the inventive concepts are not limited thereto. According to the particular embodiment, the first input point RP1 may be set to any point within the first input unit SU1, and the second input point RP2 may be set to any point within the second input unit SU2.

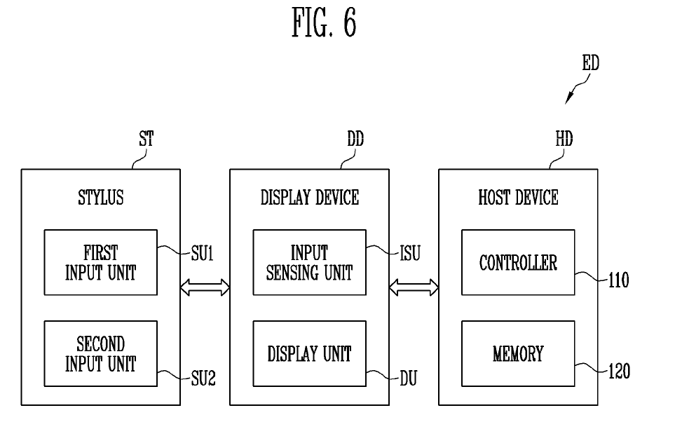

As shown in FIG. 3, the first input unit SU1 may contact the window unit WU. In this case, the stylus ST may be defined as being in a contact state. Also, unlike FIG. 3, the first input unit SU1 may be spaced apart from the window unit WU. That is, the stylus ST including the first input unit SU1 may be in a hovering state as shown in the embodiment of FIG. 5. The stylus ST in the hovering state may be described as being in a “release” state.

As shown in FIG. 3, the first input unit SU1 of the stylus ST may be in contact with the window unit WU. For example, when the stylus ST is in the contact state, the first input point RP1 of the first input unit SU1 may be located on one side of the window unit WU.

The input sensing unit ISU may sense the positions of the first input unit SU1 and the second input unit SU2, respectively, as is known in the art. For example, the input sensing unit ISU may receive information from the first input unit SU1 and the second input unit SU2. For example, the input sensing unit ISU may receive position information about the first input point RP1 from the first input unit SU1 and position information about the second input point RP2. The position information may include at least one of height information and coordinate information. The coordinate information indicates the planar coordinates on the input point, and the height information may indicate a vertical height from the top surface of the window unit WU to the input point.

According to an embodiment, the input sensing unit ISU may receive coordinate information from the first input unit SU1 and the second input unit SU2 using at least one of a reduced pressure, an electrostatic capacity and an electromagnetic induction, and the input sensing unit ISU may receive height information from the first input unit SU1 and the second input unit SU2 using an electromagnetic induction signal. However, the inventive concepts are not limited thereto, and the input sensing unit ISU may receive information from the first input unit SU1 and the second input unit SU2 in various ways known in the art.

The input sensing unit ISU may generate first coordinate information SP1 of the first input point RP1 based on the information received from the first input unit SU1, and may generate second coordinate information SP2 of the second input point RP2 based on the information received from the second input unit SU2.

The input sensing unit ISU may further generate first height information of the first input point RP1 based on the information received from the first input unit SU1, and may further generate second height information of the second input point RP2 based on the information received from the second input unit SU2.

According to one embodiment, the host device HD (see FIG. 1) may generate the correction coordinate information PP based on the first coordinate information SP1 and the second coordinate information SP2.

According to another embodiment, the host device HD may generate the correction coordinate information PP based on the first coordinate information SP1, the second coordinate information SP2, the first height information, and the second height information.

The correction coordinate information PP may be an intersection point between the extension line of the stylus ST and the display unit DU. That is, the host device HD may calculate the intersection point between the extension line of the stylus ST and the display unit DU. This will be described in detail in FIG. 4 and FIG. 5.

The display unit DU may generate a pointer image PI corresponding to the correction coordinate information PP.

According to an exemplary embodiment, the electronic device ED including the stylus ST and the method of operating the same may correct the position of the pointer and improve the accuracy of the input.

FIG. 4 is a schematic, cross sectional view of the stylus of FIG. 3 in a state contacting the window unit of a display device according to an exemplary embodiment.

For convenience of illustration, the host device HD shown in FIG. 1, and the optical clear adhesive member OCA and the grip unit GU shown in FIG. 2 are not shown in FIG. 4.

The operation of the electronic device ED (see FIG. 1) will be described below when the stylus ST (see FIG. 1) is in a contact state.

The host device HD (see FIG. 1) may receive the first coordinate information SP1 and the second coordinate information SP2 from the input sensing unit ISU. In addition, the host device HD may further receive the first height information and the second height information from the input sensing unit ISU.

The host device HD may determine the state of the stylus ST. For example, when the first height information is zero or when the first input unit SU1 contacts the window unit WU, the host device HD may determine that the stylus ST is in the contact state.

The host device HD may generate the correction coordinate information PP based on at least one of the first coordinate information SP1, the second coordinate information SP2, the first height information, and the second height information.

Specifically, the host device HD may obtain a first length L1. The first length L1 may indicate a distance between the first input point RP1 and the second input point RP2.

According to one embodiment, the first length L1 may be a predetermined value stored in a memory. For example, the first length L1 may be set at the time of shipment from the factory, or changed by the user.

According to another embodiment, the host device HD may calculate the first length L1 based on the first height information, the second height information, and a third length L3.

The host device HD may obtain a second length L2. The second length L2 may indicate a vertical distance from the upper surface of the display unit DU to the upper surface of the window unit WU. For example, the second length L2 may be determined by the thickness of the input sensing unit ISU and the window unit WU (or the thickness of the input sensing unit ISU, the window unit WU, and the optical clear adhesive member OCA). The second length L2 may be a predetermined value and may be stored in a memory. For example, the second length L2 may be set at the time of shipment from the factory, or changed by the user.

The host device HD may calculate a third length L3 based on the first coordinate information SP1 and the second coordinate information SP2. The third length L3 may indicate a distance between a point corresponding to the first coordinate information SP1 and a point corresponding to the second coordinate information SP2.

The host device HD may calculate a correction distance x based on the first length L1, the second length L2 and the third length L3. For example, the host device HD may calculate the correction distance x by using Equation 1 as follows:

x=(L2*L3)/((L1̂2−L3̂3)̂(½)), [Equation 1]

where x is the correction distance, L1 is the first length, L2 is the second length, and L3 is the third length.

The host device HD may generate the correction coordinate information PP corresponding to a point spaced from the point corresponding to the first coordinate information SP1 by the correction distance x, in the direction from the second coordinate information SP2 to the first coordinate information SP1.

The display unit DU may generate the actual desired pointer image PI (see FIG. 3) corresponding to the correction coordinate information PP.

Thus, the electronic device ED may correct the position of the pointer, and the accuracy of correction and input may be improved.

FIG. 5 is a schematic, cross sectional view of the stylus of FIG. 3 in a release (no-contact) state according to an exemplary embodiment.

For convenience of illustration, the host device HD shown in FIG. 1, and the optical clear adhesive member OCA and the grip unit GU shown in FIG. 2 are not shown in FIG. 5.

The operation of the electronic device ED (see FIG. 1) will be described below when the stylus ST (see FIG. 1) is in a release state.

The host device HD may receive the first coordinate information SP1 and the second coordinate information SP2 from the input sensing unit ISU. In addition, the host device HD may further receive the first height information and the second height information from the input sensing unit ISU.

The host device HD may determine the state of the stylus ST. For example, when the first height information is not zero or when the first input unit SU1 is not in contact with the window unit WU, the host device HD may determine that the stylus ST is in the release state.

The host device HD may generate the correction coordinate information PP based on at least one of the first coordinate information SP1, the second coordinate information SP2, the first height information, and the second height information when the stylus ST in the release state.

Specifically, the host device HD may obtain the first length L1. The first length L1 may indicate the distance between the first input point RP1 of the first input unit SU1 and the second input point RP2 of the second input unit SU2.

According to one embodiment, the host device HD may read the first length L1 from a memory. The first length L1 may be a predetermined value and may be stored in a memory. For example, the first length L1 may be set at the time of shipment from the factory or changed by the user.

According to another embodiment, the host device HD may calculate the first length L1 based on the first height information, the second height information, and the third length L3.

The host device HD may obtain the second length L2. The host device HD may read the second length L2 from the memory. The second length L2 may indicate a vertical distance from the upper surface of the display unit DU to the upper surface of the window unit WU. For example, the second length L2 may be determined by the thickness of the input sensing unit ISU and the window unit WU (or the thickness of the input sensing unit ISU, the window unit WU, and the optical clear adhesive member OCA). The second length L2 may be a predetermined value and may be stored in a memory. For example, the second length L2 may be set at the time of shipment from the factory or changed by the user.

The host device HD may calculate the third length L3 based on the first coordinate information SP1 and the second coordinate information SP2. The third length L3 may indicate a distance between a point corresponding to the first coordinate information SP1 and a point corresponding to the second coordinate information SP2.

The host device HD may obtain a fourth length L4. According to one embodiment, the host device HD may obtain the fourth length L4, based on the first height information. That is, the fourth length L4 may indicate the separation distance of the stylus ST.

For example, the fourth length L4 may indicate a vertical distance from the window unit WU to the first input point RP1. However, the inventive concepts are not limited thereto. According to another embodiment, the host device HD may read a predetermined fourth length L4 from the memory. The fourth length L4 is a predetermined value and may be stored in a memory. For example, the fourth length L4 may be set at the time of shipment from the factory or changed by the user.

The host device HD may calculate the correction distance x based on the first length L1, the second length L2, the third length L3 and the fourth length L4. For example, the host device HD may calculate the correction distance x by using the following Equation 2 as follows:

x=((L2+L4)*L3)/((L1̂2−L3̂3)̂(½)), [Equation 2]

wherein x is the correction distance, L1 is the first length, L2 is the second length, L3 is the third length, and L4 is the fourth length.

The host device HD may generate the correction coordinate information PP at a point spaced from the point corresponding to the first coordinate information SP1 by the correction distance x in the direction from the second coordinate information SP2 to the first coordinate information SP1.

The display unit DU may generate the pointer image PI (see FIG. 3) corresponding to the correction coordinate information PP.

Thus, the electronic device ED may correct the position of the pointer, and the accuracy of correction and input position may be improved.

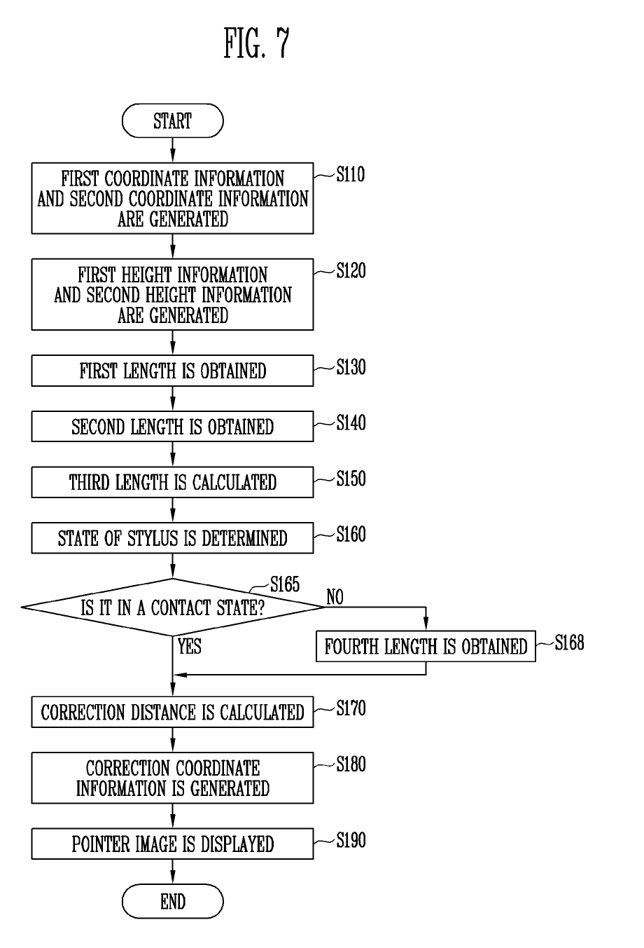

FIG. 6 is a schematic block diagram illustrating components of an electronic device constructed according to the principles of the invention.

For convenience of illustration, the window unit WU shown in FIG. 2 is not shown in FIG. 6.

The electronic device ED may include the stylus ST, the display device DD, and the host device HD

In FIG. 6, the display device DD and the host device HD are shown as separate configurations, but the inventive concepts are not limited thereto. According to the particular embodiment, the display device DD and the host device HD may be integrated.

Referring to FIGS. 1 to 6, the input sensing unit ISU may receive information from the first input unit SU1 and the second input unit SU2. For example, the input sensing unit ISU may receive the position information about the first input point RP1 from the first input unit SU1 and the position information about the second input point RP2 from the second input unit SU2.

The input sensing unit ISU may generate the first coordinate information SP1 of the first input point RP1 based on the information received from the first input unit SU1, and may generate the second coordinate information SP2 of the second input point RP2 based on the information received from the second input unit SU2.

The input sensing unit ISU may further generate first height information of the first input point RP1 based on the information received from the first input unit SU1, and may further generate second height information of the second input point RP2 based on the information received from the second input unit SU2.

The host device HD may include a controller 110 for controlling the overall operation of the host device HD and a memory 120 capable of storing data/information.

The controller 110 may determine the state of the stylus ST.

For example, when the first height information is 0, or when the first input unit SU1 contacts the window unit WU, the controller 110 may determine that the stylus ST is in a contact state.

For example, when the first height information is larger than 0, or when the first input unit SU1 is not in contact with the window unit WU, the controller 110 may determine that the stylus ST is in a release state.

The controller 110 may generate the correction coordinate information PP based on at least one of the first coordinate information SP1, the second coordinate information SP2, the first height information, and the second height information. The correction coordinate information PP may be an intersection point between the extension line of the stylus ST and the display unit DU.

Specifically, the controller 110 may obtain the first length L1 and the second length L2. Further, the controller 110 may calculate the third length L3 based on the first coordinate information SP1 and the second coordinate information SP2.

The controller 110 may obtain the fourth length L4 when the stylus ST is in the release state. According to one embodiment, the controller 110 may obtain the fourth length L4 based on the first height information. However, the inventive concepts are not limited thereto. According to another embodiment, the controller 110 may read the fourth length L4 from the memory 120. The fourth length L4 may be a predetermined value and may be stored in the memory 120. For example, the fourth length L4 may be set at the time of shipment from the factory or changed by the user.

The controller 110 may calculate the correction distance x based on the first length L1, the second length L2 and the third length L3 when the stylus ST is in the contact state.

The controller 110 may calculate the correction distance x based on the first length L1, the second length L2, the third length L3 and the fourth length L4 when the stylus ST in the release state.

The controller 110 may generate the correction coordinate information PP at a point distanced from the point corresponding to the first coordinate information SP1 by the correction distance x, in the direction from the second coordinate information SP2 to the first coordinate information SP1.

The display unit DU may generate the pointer image PI (see FIG. 3) corresponding to the correction coordinate information PP.

Thus, the electronic device ED may correct the position of the pointer, and the accuracy of correction and input may be improved.

FIG. 7 is a flowchart for a exemplary method of operating an electronic device according to the principles of the invention.

Referring to FIGS. 1 to 6, in step S110, the input sensing unit ISU may generate the first coordinate information SP1 and the second coordinate information SP2.

In step S120, the input sensing unit ISU may generate the first height information and the second height information. However, depending on the embodiment, this step may be omitted.

In step S130, the controller 110 may obtain the first length L1.

According to one embodiment, the controller 110 may read the first length L1 from the memory 120. According to another embodiment, the controller 110 may calculate the first length L1 based on the first height information, the second height information, and the third length L3.

In step S140, the controller 110 may obtain the second length L2. For example, the controller 110 may read the second length L2 from the memory 120.

In step S150, the controller 110 may calculate the third length L3. For example, the controller 110 may calculate the third length L3 based on the first coordinate information SP1 and the second coordinate information SP2.

In step S160, the controller 110 may determine the state of the stylus ST.

If the stylus ST is not in the contact state (NO in S165), the controller 110 may further obtain the fourth length L4 in step S168.

According to one embodiment, the controller 110 may obtain the fourth length L4 based on the first height information. However, the inventive concepts are not limited thereto. According to another embodiment, the controller 110 may read the predetermined fourth length L4 from the memory 120. The fourth length L4 may be a predetermined value and may be stored in the memory 120. For example, the fourth length L4 may be set at the time of shipment from the factory or changed by the user.

In step S170, the controller 110 may calculate the correction distance x.

In step S180, the controller 110 may generate the correction coordinate information PP.

For example, the controller 110 may generate the correction coordinate information PP at a point distanced from the point corresponding to the first coordinate information SP1 by the correction distance x, in the direction from the second coordinate information SP2 to the first coordinate information SP1.

In step S190, the display unit DU may generate the pointer image PI in correspondence with the correction coordinate information PP.

According to the principles and exemplary embodiments of the invention, the electronic device ED including the stylus ST and the method of operating the same may correct the position of the pointer. According to the principles and exemplary embodiments of the invention, the electronic device ED including the stylus ST and the method of operating the same may improve the accuracy of correction of the input position.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An electronic device comprising:
an input member including a first input unit and a second input unit spaced apart from each other;
an input sensing unit to sense a position of the first input unit and a position of the second input unit; and
a processor to generate correction coordinate information based on the position of the first input unit and the position of the second input unit.

2. The electronic device of claim 1, further comprising:
a display unit to display a pointer image corresponding to the correction coordinate information; and
a window unit disposed on the display unit.

3. The electronic device of claim 2, wherein the correction coordinate information corresponds to an intersection point between an extension line of the input member and the display unit.

4. The electronic device of claim 3, wherein the first input unit and the second input unit are arranged along the extension line of the input member.

5. The electronic device of claim 4, wherein the input sensing unit is configured to generate first coordinate information and second coordinate information indicating planar coordinates of a first input point and a second input point of the first input unit and the second input unit, respectively.

6. The electronic device of claim 5, wherein the processor is configured to obtain a first length indicating a first distance between the first input point and the second input point and obtain a second length indicating a second distance from an upper surface of the display unit to an upper surface of the window unit.

7. The electronic device of claim 6, wherein the first length and the second length are predetermined values and are stored in a memory.

8. The electronic device of claim 6, wherein the processor is configured to calculate a third length indicating a third distance between a point corresponding to the first coordinate information and a point corresponding to the second coordinate information.

9. The electronic device of claim 8,
wherein, when the input member is in a contact state, the host device is configured to calculate a correction distance using Equation 1,
x=(L2*L3)/((L1̂2−L3̂3)̂(½)), [Equation 1]
wherein x is the correction distance, L1 is the first length, L2 is the second length, and L3 is the third length.

10. The electronic device of claim 9,
wherein the processor is configured to generate the correction coordinate information corresponding to a point spaced by the correction distance from a point corresponding to the first coordinate information in a direction from the second coordinate information to the first coordinate information.

11. The electronic device of claim 8,
wherein the input sensing unit is configured to generate first height information and second height information indicating a distance of the first input point from the window unit and a distance of the second input point from the window unit, respectively.

12. The electronic device of claim 11,
wherein, when the input member is in a release state, the host device is configured to obtain a fourth length based on the first height information.

13. The electronic device of claim 12,
wherein, the processor is configured to calculate the correction distance using Equation 2,
x=((L2+L4)*L3)/((L1̂2−L3̂3)̂(½)), [Equation 2]
wherein x is the correction distance, L1 is the first length, L2 is the second length, L3 is the third length and L4 is the fourth length.

14. The electronic device of claim 11,
wherein, when the input member is in a release state, the host device is configured to obtain a fourth length, and
wherein the fourth length is a predetermined value and is stored in a memory.

15. The electronic device of claim 1,
wherein the input member comprises a stylus.

16. The electronic device of claim 15,
wherein the first input unit is formed as a pen tip of the stylus.

17. A method of operating an electronic device having an input member with a first input unit and a second input unit spaced apart from each other, an input sensing unit, a host device to generate correction coordinate information, a display unit to display an image, and a window unit disposed on the display unit, the method comprising the steps of:
generating first coordinate information and second coordinate information representative of planar coordinates of a first input point and a second input point of the first input unit and the second input unit, respectively;
obtaining a first length indicating a distance between the first input point and the second input point;
obtaining a second length indicating a distance from an upper surface of the display unit to an upper surface of the window unit;
calculating a third length indicating a distance between a point corresponding to the first coordinate information and a point corresponding to the second coordinate information;
determining a state of the input member;
is calculating a correction distance when the input member is in a first state; and
generating the correction coordinate information based on the first coordinate information, the second coordinate information, and the correction distance.

18. The method of claim 17, wherein the first state is a contact state and the step of calculating of the correction distance comprises:
calculating the correction distance using Equation 1,
x=(L2*L3)/((L1̂2−L3̂3)̂(½)), [Equation 1]
wherein x is the correction distance, L1 is the first length, L2 is the second length, and L3 is the third length.

19. The method of claim 17, wherein the first state is a release state and further comprising the step of:
obtaining a fourth length indicating a distance of the first input point from the window unit.

20. The method of claim 19, wherein the step of calculating of the correction distance comprises:
calculating the correction distance using Equation 2,
x=((L2+L4)*L3)/((L1̂2−L3̂3)̂(½)), [Equation 2]
wherein x is the correction distance, L1 is the first length, L2 is the second length, L3 is the third length and L4 is the fourth length.
